(19) United States
(12) Patent Application Publication
(10) Pub. No.: US 2006/0208403 A1
(43) Pub. Date: Sep. 21, 2006

(54) Air spring assembly with flexible can

(75) Inventor: Jeffrey M. Lloyd, Auburn Hills, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/081,452

(22) Filed: Mar. 16, 2005

(51) Int. Cl. F16F 9/04

(52) U.S. Cl. 267/64.23; 267/122

(57) ABSTRACT

An air spring assembly cooperates with a shock absorber to dampen road load inputs to a vehicle. The air spring assembly includes an upper mount that is secured to a vehicle structure and an air spring piston that is supported by the shock absorber. A flexible member extends between the upper mount and the air spring piston. The flexible member includes a bellows spring portion with an upper end secured to the upper mount and a rolling lobe spring portion with a lower end secured to the air spring piston. A reinforcing ring cooperates with the bellows spring portion and the rolling lobe spring portion to control spring rate and reduce hysteresis.

### TECHNICAL FIELD

The subject invention relates to an air spring assembly including a bellows spring portion and a rolling lobe spring portion that both cooperate with a common reinforcing sleeve to control spring rate and reduce hysteresis.

### BACKGROUND OF THE INVENTION

An air spring assembly is mounted to a shock absorber to form a strut assembly. The strut assembly is mounted between a vehicle wheel and a vehicle frame member. The strut assembly dampens road load inputs to a vehicle to improve passenger ride and comfort.

A traditional air spring assembly includes an air spring piston supported by the shock absorber and an upper mount that secures the air spring assembly to the vehicle frame member. A flexible air bag is secured to the air spring piston and defines a fluid volume that controls a spring rate for the air spring assembly. The flexible air bag includes a rolling lobe portion that moves in response to movement of the air spring piston.

Some applications require a lower or reduced spring rate. In order to reduce the spring rate, an “effective area” needs to be reduced or the fluid volume of the air spring assembly needs to be increased. Effective area is defined in part by the size of the air bag. When the fluid volume of the air spring assembly is increased, the diameter of the air bag is increased, which in turn increases the effective area. Thus, it is advantageous to keep the diameter of the air bag small while providing a large volume to reduce spring rate.

One solution for providing a large volume without increasing air bag diameter has involved using a large metal can. The metal can is secured to the upper mount at one end and is secured to the air bag at an opposite end. The rolling lobe portion moves with the air spring piston relative to the metal can during road load inputs.

One problem associated with the rolling lobe portion is hysteresis. Hysteresis is a lagging of a physical reaction of the air bag in response to an input. In order to reduce hysteresis of the air spring assembly, a thinner rolling lobe portion is required. However, a thinner rolling lobe portion requires a second metal can for reinforcement. Because the rolling lobe portion moves, a flexible connection member is required to connect the second metal can to the air bag. The flexible connection member typically comprises a flexible sleeve that interconnects the two cans.

This configuration is expensive and time consuming to assemble. It would be beneficial to provide a simplified air spring assembly that eliminates the need for multiple metal cans, provides reduced spring rate and reduced hysteresis, and which is more cost effective.

### SUMMARY OF THE INVENTION

An air spring assembly includes an upper mount supported by a vehicle structure, an air spring piston, and a flexible member extending between the upper mount and air spring piston. A reinforcing sleeve cooperates with the flexible member to control spring rate and reduce hysteresis.

In one disclosed embodiment, the flexible member includes an outer surface in direct contact with the reinforcing sleeve and an inner surface that is in direct contact with an inner ring. The inner ring secures the flexible member to the reinforcing sleeve. Preferably, the inner ring is the sole attachment interface between the flexible member and the reinforcing sleeve. In one example, the attachment interface comprises a crimped attachment with the flexible member being compressed between the reinforcing sleeve and the inner ring.

The flexible member includes a bellows spring portion having an upper end secured to the upper mount, and a rolling lobe spring portion, which has a lower end secured to the air spring piston. The reinforcing sleeve cooperates with the bellows spring portion to control the spring rate. The reinforcing sleeve cooperates with the rolling lobe spring portion to reduce hysteresis. The bellows spring portion and the rolling lobe spring portion can be integrally formed as a single piece or can be formed from multiple pieces.

In one disclosed embodiment, the reinforcing sleeve includes a rigid body with a reinforcing ring formed about an upper perimeter of the rigid body. The reinforcing sleeve includes an arcuate surface that shapes the bellows spring portion during road load inputs. The arcuate surface is formed by a rolled-over lip that extends transversely to the rigid body.

By using a flexible bellows spring portion between the upper mount and the reinforcing sleeve, additional volume can be utilized without increasing spring rate in additional to supplying a flexible attachment interface for the reinforcing sleeve. These and other features of the present invention can be best understood from the following specification and drawings, the following of which is a brief description.

### BRIEF DESCRIPTION OF THE DRAWINGS

FIG. 1 is a schematic side view of an air spring assembly installed between a vehicle structure and a wheel.

FIG. 2 is cross-sectional view showing one example of an air spring assembly incorporating the subject invention.

FIG. 3 is a cross-sectional view showing another example of an air spring assembly incorporating the subject invention.

### DETAILED DESCRIPTION OF THE PREFERRED EMBODIMENT

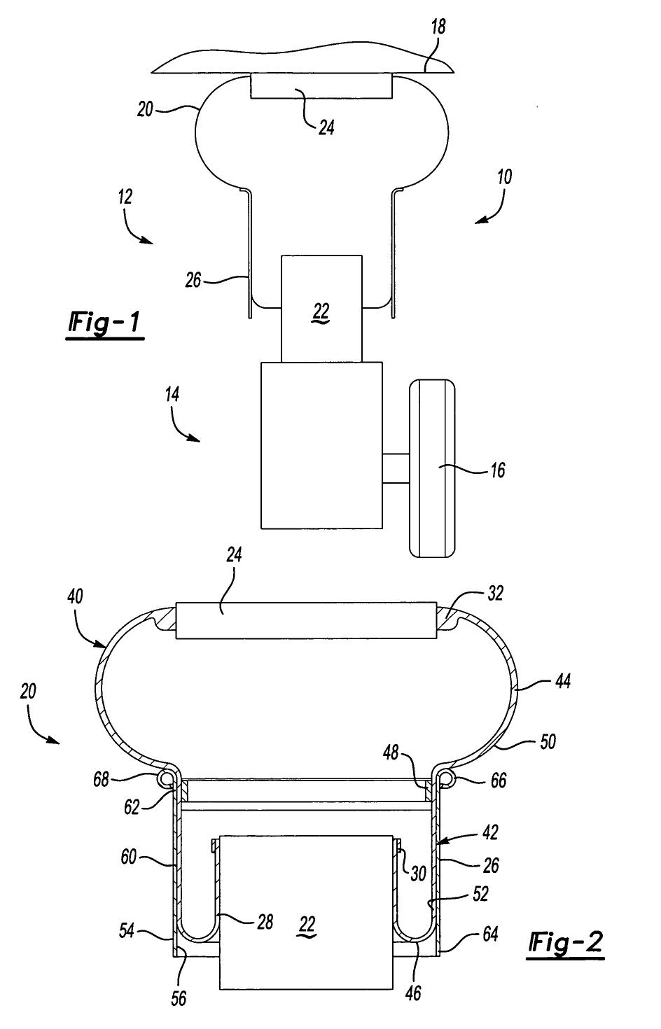

A strut assembly 10, shown in FIG. 1, includes an air spring assembly 12 and a shock absorber assembly 14. The strut assembly 10 is positioned between a vehicle wheel 16 and a vehicle frame member 18 to dampen road load inputs.

The air spring assembly 12 includes a flexible spring member 20 and an air spring piston 22. The flexible spring member 20 is attached to an upper mount 24 that is supported on the vehicle frame member 18. The flexible spring member 20 is also attached to the air spring piston 22. The air spring assembly 12 includes a reinforcing sleeve 26 that cooperates with the flexible spring member 20 to control spring rate and reduce hysteresis.

As shown in FIG. 2, a lower end 28 of the flexible spring member 20 is attached for movement with the air spring piston 22 in response to road load inputs. The lower end 28 is attached to the air spring piston 22 with a crimp ring 30 or other similar attachment member. An upper end 32 of the flexible spring member 20 can be attached to the upper mount 24 with any attachment mechanism known in the art. Optionally, the upper end 32 of the flexible spring member 20 could be attached to a can (not shown), which would be supported by the upper mount 24.

The flexible spring member 20 includes an upper portion 40 and a lower portion 42. The upper portion 40 is a bellows air spring 44 and the lower portion 42 is a rolling lobe air spring 46. The reinforcing sleeve 26 is attached to the flexible spring member 20 with an inner member, such as an inner ring 48. In one example, the inner ring 48 forms a crimp attachment interface such that the flexible spring member 20 is compressed between the reinforcing sleeve 26 and the inner ring 48. The sole attachment interface for the reinforcing sleeve 26 is at the inner ring 48. In other words, the reinforcing sleeve 26 is not attached to any other component or structure except to the flexible spring member 20 at the inner ring 48. This means the reinforcing sleeve 26 can move with the flexible spring member 20 as needed during road load inputs.

The flexible spring member 20 includes an outer surface 50 and an inner surface 52. The reinforcing sleeve 26 includes an outer surface 54 and an inner surface 56. The outer surface 50 of the flexible spring member 20 directly engages the inner surface 56 of the reinforcing sleeve 26. The inner surface 52 of the flexible spring member 20 directly engages the inner ring 48.

The reinforcing sleeve 26 includes a rigid cylindrical body 60 with an upper end 62 and a lower end 64. The upper end 62 includes a reinforcing ring 66 formed about a perimeter of the upper end 62. The reinforcing ring 66 has a greater outer diameter than an outer diameter of the rigid cylindrical body 60. The reinforcing ring 66 includes a rolled lip portion that defines an arcuate surface 68, which engages the outer surface 50 of the flexible spring member 20. The arcuate surface 68 shapes the bellows air spring 44 in response to road load inputs.

The bellows air spring 44 and the rolling lobe air spring 46 both cooperate with the reinforcing sleeve 26. The bellows air spring 44 cooperates with the arcuate surface 68 on the reinforcing ring 66 to shape the bellows air spring 44 as described above. An outer surface of the rolling lobe air spring 46 engages the inner surface 56 of the reinforcing sleeve 26. The contact area between the rolling lobe air spring 46 and the reinforcing sleeve 26 changes as the rolling lobe air spring 46 moves with the air spring piston 22.

As shown in FIG. 2, the bellows air spring 44 and the rolling lobe air spring 46 are preferably integrally formed from a single piece of resilient material. One example of a material that could be used to form the bellows air spring 44 and the rolling lobe air spring 46 is rubber, however, any other similar material known in the art could also be used.

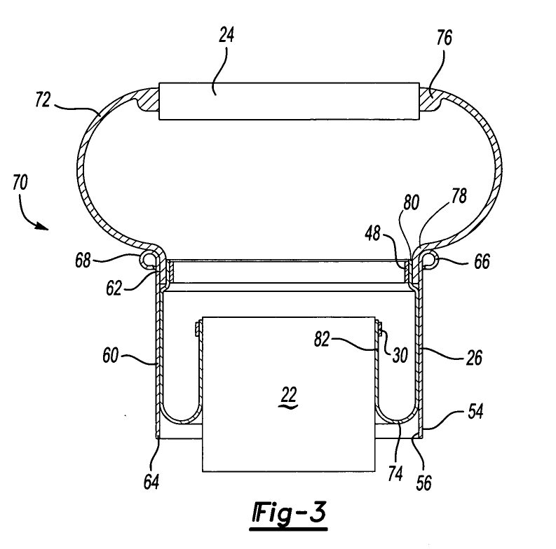

In another embodiment, shown in FIG. 3, a flexible member 70 includes a bellows air spring 72 and a rolling lobe air spring 74 that are separate pieces formed from resilient material, such as rubber, for example. In this configuration, the bellows air spring 72 includes an upper end 76 that is attached to the upper mount 24 and a lower end 78 that is received within the reinforcing sleeve 26. The rolling lobe air spring 74 includes an upper end 80, which is positioned in an overlapping relationship to the lower end 78 of the bellows air spring 72, and a lower end 82 that is fixed to the air spring piston 22. The inner ring 48 crimps or compresses the upper end 80 of the rolling lobe air spring 74 and the lower end 78 of the bellows air spring 72 against the inner surface 56 of the reinforcing sleeve 26.

In either configuration, by using a bellows air spring 44 or 72, fluid volume can be increased without increasing the spring rate. Thus, reduced spring rates can easily be provided. Further, the rolling lobe air spring 46 or 74, can be formed with a reduced thickness compared to the bellows air spring 44 or 72 to reduce hysteresis. The reinforcing sleeve 26 provides additional support for the rolling lobe air spring 46 or 74. The bellows air spring 44, 72 provides a flexible attachment mechanism for the reinforcing sleeve 26, which allows the reinforcing sleeve 26 to follow an arc that the flexible spring member 20 may travel within during vehicle operation.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An air spring assembly comprising:
an upper mount;
a flexible spring member having an upper portion attached to said upper mount and a lower portion attached to a piston;
a reinforcing sleeve surrounding at least a portion of said flexible spring member and cooperating with said upper and said lower portions to control spring rate and hysteresis; and
an inner member that secures said flexible spring member to said reinforcing sleeve.

2. The air spring assembly as set forth in claim 1 wherein said upper portion comprises a bellows air spring and said lower portion comprises a rolling lobe air spring.

3. The air spring assembly as set forth in claim 2 wherein said bellows air spring includes an upper spring end that is attached to said upper mount and said rolling lobe air spring includes a lower spring end that is attached to the piston.

4. The air spring assembly as set forth in claim 3 wherein said reinforcing sleeve includes a rigid body having an upper sleeve end that cooperates with said bellows air spring to control the spring rate and a lower sleeve end that cooperates with said rolling lobe air spring to control the hysteresis.

5. The air spring assembly as set forth in claim 4 wherein said upper sleeve end includes a reinforcing ring portion defining an arcuate surface that directly engages an outer surface of said bellows air spring to shape said bellows air spring during load input.

6. The air spring assembly as set forth in claim 5 wherein said rigid body is defined by a first diameter and said reinforcing ring portion is defined by a second diameter that is greater than said first diameter.

7. The air spring assembly as set forth in claim 1 wherein said reinforcing sleeve includes an upper ring portion having a rolled lip, said flexible spring member being crimped between said inner member and said upper ring portion.

8. The air spring assembly as set forth in claim 1 wherein said flexible spring member includes an inner surface and an outer surface with said reinforcing sleeve directly engaging said outer surface and said inner member directly engaging said inner surface such that said inner member forms a sole attachment interface between said flexible spring member and said reinforcing sleeve.

9. The air spring assembly as set forth in claim 1 wherein said reinforcing sleeve is movable relative to said upper mount.

10. An air spring assembly comprising:
an upper mount adapted to be supported on a vehicle structure;
an air spring piston movable relative to said upper mount;
a bellows air spring attached to said upper mount;
a rolling lobe air spring attached to said air spring piston;
a reinforcing sleeve surrounding at least a portion of said bellows air spring and said rolling lobe air spring; and
an inner ring securing said bellows air spring and said rolling lobe air spring to said reinforcing sleeve.

11. The air spring assembly as set forth in claim 10 wherein said bellows air spring and said rolling lobe air spring are integrally formed together as a single piece from a resilient material.

12. The air spring assembly as set forth in claim 10 wherein said reinforcing sleeve includes a rigid body with a reinforcing ring formed around an upper end of said rigid body, said reinforcing ring providing an arcuate surface that directly engages an outer surface of said bellows air spring.

13. The air spring assembly as set forth in claim 12 wherein said reinforcing ring comprises a transversely extending rolled lip formed about a perimeter of said upper end.

14. The air spring assembly as set forth in claim 10 wherein said bellows air spring includes a bellows upper end and a bellows lower end, and said rolling lobe air spring includes a lobe upper end and a lobe lower end, and wherein said bellows lower end and said lobe upper end are compressed directly between said inner ring and said reinforcing sleeve.

15. The air spring assembly as set forth in claim 14 wherein said bellows upper end is fixed to said upper mount and said lobe lower end is secured to move with said air spring piston.

16. The air spring assembly as set forth in claim 10 wherein said reinforcing sleeve is solely attached to said bellows air spring and said rolling lobe air spring at said inner ring.

17. The air spring assembly as set forth in claim 10 wherein said bellows air spring has a greater material thickness than said rolling lobe air spring.
